(19) United States
(12) Patent Application Publication
(10) Pub. No.: US 2026/0353483 A1
(43) Pub. Date: Nov. 5, 2026

(54) SYSTEM AND METHOD FOR PAIRING A MOBILE DEVICE TO AN INFOTAINMENT SYSTEM OF A VEHICLE

(71) Applicants: FCA US LLC, Auburn Hills, MI (US); Stellantis Auto SAS, Poissy (FR)

(72) Inventors: Daniel P. Cashen, Auburn Hills, MI (US); Emily A. Robb, Auburn Hills, MI (US)

(21) Appl. No.: 19/194,645

(22) Filed: Apr. 30, 2025

(51) Int. Cl. H04W 76/14; H04W 12/50; H04W 76/30

(52) U.S. Cl. CPC H04W 76/14; H04W 12/50; H04W 76/30

(57) ABSTRACT

A system and method for pairing a mobile device to an infotainment system of a vehicle may include determining that a control system of the vehicle and an infotainment system of the vehicle are operational, determining that a mobile device is within an interior of the vehicle, and pairing the mobile device to the infotainment system of the vehicle.

### FIELD

The present disclosure relates to a system and method for pairing a mobile device to an infotainment system of a vehicle.

### BACKGROUND

Phone calls or media being played on a mobile device may be unintentionally transferred to an in-vehicle system without the user of the mobile device intending to use the vehicle or without the user or mobile device being in the vehicle. This may interrupt phone calls or media being played on the mobile device, with the audio of such phone calls or media being played within the vehicle while the user is not within the vehicle.

### SUMMARY

In at least some implementations, a method for pairing a mobile device to an infotainment system of a vehicle includes determining that a control system of the vehicle and an infotainment system of the vehicle are operational, determining that a mobile device is within an interior of the vehicle, and pairing the mobile device to the infotainment system of the vehicle.

In at least some implementations, the method further comprises determining that an occupant is within the interior of the vehicle.

In at least some implementations, determining that an occupant is within the interior of the vehicle is accomplished by detecting one or more of: actuation of an input within the interior of the vehicle, opening of one or more vehicle doors, that a vehicle seat is occupied using a seat sensor or other interior sensor, or that a key fob or a vehicle access device used to access the vehicle is within the interior of the vehicle.

In at least some implementations, determining that the mobile device is within the interior of the vehicle includes determining that a distance that the mobile device is from a receiver of a communications device of the vehicle is less than a distance between the receiver and a boundary of the interior of the vehicle.

In at least some implementations, the distance between the mobile device and the receiver of the communications device is determined using a signal strength between the mobile device and the receiver of the communications device or time-of-flight calculations.

In at least some implementations, the signal is an ultra-wideband signal.

In at least some implementations, pairing the mobile device to the infotainment system of the vehicle includes permitting media from the mobile device to be transferred to and played through the infotainment system.

In at least some implementations, media includes phone calls, audio, and video.

In at least some implementations, when multiple mobile devices are determined to be within the interior of the vehicle, a mobile device having a higher priority than the other mobile devices is paired to the infotainment system of the vehicle and the order of priority may be pre-set by a vehicle occupant or chronologically determined by the date or time of first connection to the vehicle.

In at least some implementations, the method further comprises determining that the mobile device is no longer in the vehicle and disconnecting the mobile device from the infotainment system.

In at least some implementations, disconnecting the mobile device is done by the vehicle control system even when the mobile device is within a distance of the vehicle in which wireless connection of the mobile device to the vehicle control system is still possible.

In at least some implementations, a system for pairing a mobile device to an infotainment system of a vehicle includes a vehicle communications system configured to communicate with a mobile device, an infotainment system configured playback media from the mobile device or output media to the mobile device, and a control system. The control system is configured to communicate with the vehicle communications system and the infotainment system, determine the vehicle is ready for use, determine the mobile device is within an interior of the vehicle, and pair the mobile device to the infotainment system of the vehicle.

In at least some implementations, the control system is configured to determine that a user of the mobile device is within the vehicle, wherein determining the user of the mobile device is within the vehicle includes determining a vehicle powertrain system has been switched to an on position, one or more vehicle doors have been unlocked or opened, a vehicle occupant has entered the vehicle using a seat sensor or other interior sensor, detecting that the key fob or a vehicle access device used to access the vehicle is within the vehicle, or a change in the position of a drivetrain of the vehicle has occurred.

In at least some implementations, determining the mobile device is within the interior of the vehicle includes determining a distance that the mobile device is from a receiver of the communications device of the vehicle is less than a distance between the receiver and a boundary of the interior of the vehicle.

In at least some implementations, the distance between the mobile device and the receiver of the communications device is determined using a signal strength between the mobile device and the receiver of the communications device or time-of-flight calculations.

In at least some implementations, pairing the mobile device to the infotainment system of the vehicle includes permitting media from the mobile device to be transferred to and played through the infotainment system.

In at least some implementations, media includes phone calls, audio, and video.

In at least some implementations, when multiple mobile devices are determined to be within the interior of the vehicle, a mobile device having a higher priority than the other mobile devices is paired to the infotainment system of the vehicle and the order of priority may be pre-set by a vehicle occupant or chronologically determined by the date or time of first connection to the vehicle.

In at least some implementations, the control system is configured to determine when the mobile device is no longer in the vehicle and disconnect the mobile device from the infotainment system.

In at least some implementations, disconnecting the mobile device is done by the vehicle control system even when the mobile device is within a distance of the vehicle in which wireless connection of the mobile device to the vehicle control system is still possible.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 shows a perspective view of a vehicle with a system for pairing a mobile device to an infotainment system of the vehicle; and

FIG. 2 shows a flowchart for a method for pairing the mobile device to the infotainment system of the vehicle.

### DETAILED DESCRIPTION

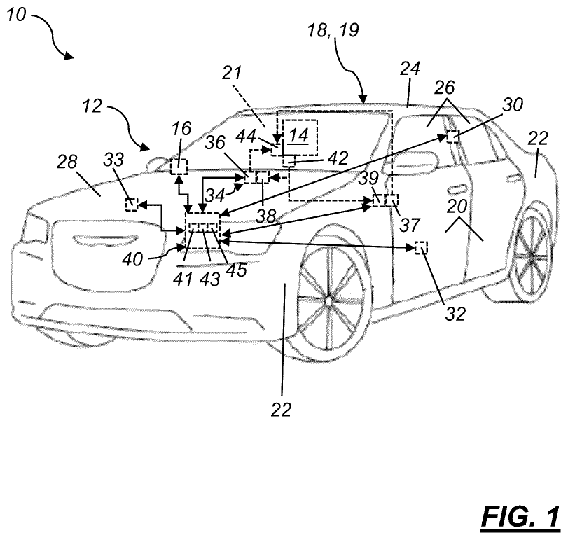

Referring in more detail to the drawings, FIG. 1 illustrates a vehicle 10 with a system 12 for pairing a mobile device 14 to an infotainment system 16 of the vehicle 10. The vehicle 10 has a body 18 with body panels that define at least part of an exterior 19 and an interior 21 of the vehicle 10. The exterior 19 is defined by an outer surface of the body 18, visible from outside the vehicle 10, and the interior 21 of the vehicle 10 is the space at least partially enclosed by the body 18 of the vehicle 10 and defined at least in part by a passenger cabin. The body panels may include doors 20, fenders 22, a roof 24, windows 26, and a hood 28.

The doors 20 may be configured to provide selective access to the interior 21 of the vehicle 10. For example, in the implementations shown in FIG. 1, there are two left doors on a left side of the vehicle and two right doors on a right side of the vehicle 10 (not shown). The doors 20 are movable between open and closed positions. In the open position, the doors 20 provide access to the interior 21, and in the closed position, the doors 20 prevent access to the interior. One or more door position sensors 30 may be associated with each door 20 and may be configured to determine the position of each door 20. For example, the door position sensors 30 may determine when one or more of the doors 20 is in the closed position or is moved at least a threshold amount from the closed position.

The windows 26 may be at least partially movable to expose a portion of the interior 21 to the environment outside the vehicle 10, or may be fixed to one or more body panels or the frame of the vehicle 10. In some implementations, the windows 26 may be movable and stored at least partially within a body panel or door 20 to provide access to the interior of the vehicle 10.

One or more seats may be mounted within the interior of the vehicle 10. At least one of the seats may be configured to support an operator of the vehicle 10, while additional seats may be configured to support other occupants of the vehicle 10. A seat sensor 32 may be integrated with the seat and may be configured to determine whether an operator is in the seat. For example, the seat sensor 32 may be configured to determine when a weight supported by the seat exceeds a predetermined threshold. Although, other implementations of seat sensors 32 are possible, such as, but not limited to optical sensors (e.g. cameras), radar sensors, lidar sensor, and/or motion detectors that may visually detect a person in the seat and/or detect the motion of a person in the seat.

The vehicle 10 includes a powertrain system 33 to propel the vehicle 10. The powertrain system 33 may include an internal combustion engine, one or more electric motors, or a combination of an internal combustion engine and electric motors. The operator of the vehicle 10 may switch the powertrain system 33 between an on position in which the powertrain system 33 can propel the vehicle 10, and an off position using a powertrain control within the interior, which may be an ignition or “on” switch.

A communications device 34 of the vehicle may have a transmitter 36 and a receiver 38. The transmitter 36 of the communications device 34 is capable of transmitting wireless communications and the receiver 38 of the communications device 34 is capable of receiving wireless communications. For example, wireless communications may be cellular, ultra-wideband (UWB), WiFi, satellite communications, radio, Bluetooth, Bluetooth low-energy (BLE), near field communication (NFC), or others. The communications device 34 may be defined by separate components (e.g. for the transmitter 36 and receiver 38) or integrated into a single component (e.g. a transceiver) depending on the embodiment. In at least some implementations, the communications device 34 may have multiple receivers 38 positioned at various positions throughout the interior of the vehicle 10. Each of the receivers is capable of receiving wireless communications and in some instances may receive a common wireless signal concurrently.

A vehicle control system 40 is in communication with the communications device 34 such that the control system 40 can transmit and receive signals and information via the communications device 34. The control system 40 has one or more controllers or processors 41, memory 43 and instructions or programs 45 stored in the memory or otherwise accessible by the processor(s). In order to perform the functions and desired processing set forth herein, as well as the computations therefore, the control system 40 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing. For example, the control system 40 may include input signal processing and filtering to enable accurate sampling and conversion or acquisitions of such signals from communications interfaces and sensors. As used herein the terms control system 40 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. In some implementations, the control system 40 may have or be defined by one or multiple vehicle controllers, such as but not limited to, an infotainment module, a telematics module, body control module, powertrain control module, and the like, and the controllers may be independent or networked to each other. Each of the controllers may communicate with one or more vehicle components or system components.

The term “memory” or “storage” 43 as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory 43 can store an operating system and/or instructions executable by a processor or controller or the like to enable control or allocate resources of a computing device.

The vehicle infotainment system 16 may include a user interface capable of outputting sound, inputting sound, or otherwise communicating with the vehicle occupant. The vehicle infotainment system 16 may include a speaker capable of audibly communicating information to the user, a microphone capable of recording audio from within the interior of the vehicle, and a display capable of displaying images viewable by the vehicle occupants. The control system 40 may be in communication with the infotainment system 16 to provide various multimedia content and information to vehicle occupants, and to provide an interface by which a user can enter information via the display or related inputs. In at least some implementations, user input via the infotainment system 16 may be provided through a touch-sensitive display, allowing vehicle occupant(s) to navigate through menus, adjust vehicle settings, and control features by tapping or swiping on the touchscreen. Some implementations may utilize physical controls to recognize input from a vehicle occupant such as button, knobs, or dials positioned within the interior of the vehicle 10. Other implementations may use voice recognition through integrated voice control systems allowing a vehicle occupant to operate vehicle functions using voice commands.

The mobile device 14 has one or more processors, memory, and instructions or programs stored in the memory or otherwise accessible by the processors. The mobile device 14 has a device transmitter 42 capable of transmitting signals wirelessly, and a device receiver 44 capable of receiving signals wirelessly. Communication to and from the mobile device 14 can be any form of wireless communication such as, but not limited to cellular, WiFi, Bluetooth, satellite communications, radio, or others. In some implementations, the mobile device 14 may be configured to provide access to the vehicle 10, such as by unlocking a door 22, operating a window 26, or remotely starting or turning on the vehicle 10 or various vehicle functions via commands sent wirelessly from the mobile device 14 to the vehicle 10.

The mobile device 14 may be capable of receiving audio and video wirelessly or from its internal memory. It can then output audio through either the integrated speaker or an external device connected to the mobile device 14, such as headphones, an external speaker, or the infotainment system 16. Similarly, video can be output through the built-in display of the mobile device 14 or to an external display, such as a television or the infotainment system 16. Therefore, when connected to one or more external devices, the mobile device 14 may route audio and/or video to those devices, instead of using the integrated speaker or display of the mobile device 14.

Furthermore, the mobile device 14 may be capable of recording audio, through an integrated microphone, and video, via a built-in camera, with both types of data potentially transmitted to one or more external device(s) via wireless communication. The external devices may be a microphone, speaker, display, or camera separate from the mobile device. In such cases, the mobile device 14 can receive wireless signals from these external devices and use them instead of its integrated components, when applicable.

The control system 40 may remember (e.g. may store in memory 43 an identification code of) one or more mobile devices 14 that have previously wirelessly connected and communicated with the vehicle 10 via the communications device 34. So that, the mobile device 14, when in range of the vehicle communications device 34, and when the vehicle 10 is powered on, may automatically connect and resume wireless communication with the communications system 34 and control system 40. Thus, when an operator or vehicle occupant brings a mobile device 14 within a working range of the communication device 34, media being played or recorded using the integrated microphone, speaker, or display of the mobile device 14 may be unintentionally transferred to the infotainment system 16 and played within the vehicle interior 21. This may lead to an interruption in use of the mobile device 14 wherein ongoing outputs (e.g. audio and/or video) are transferred to the vehicle 10 and output within the vehicle interior 21 by the infotainment system 16, even when the person using the mobile device 14 is not within the vehicle interior 21. Accordingly, the control system 40 is adapted to inhibit or prevent unintentional transfers of media to the infotainment system 34 of the vehicle 10.

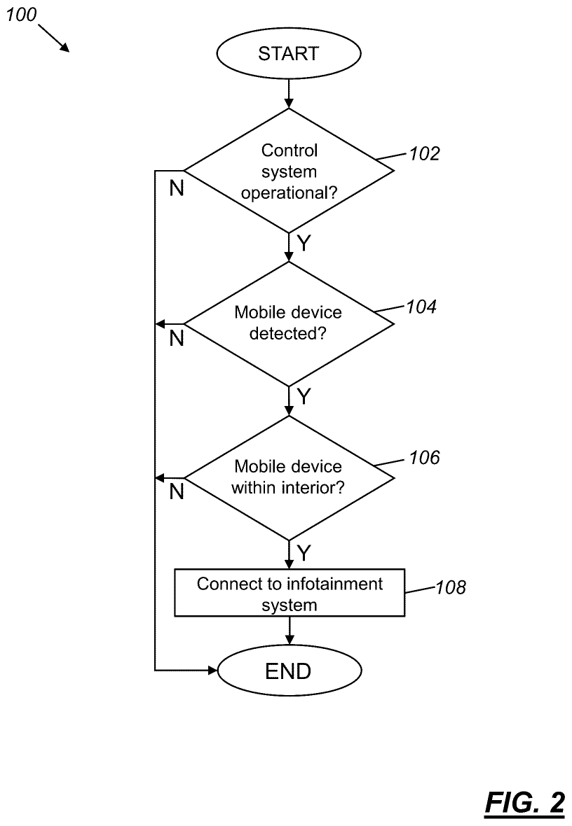

A method 100 for pairing the mobile device 14 to the infotainment system 34 of the vehicle 10 is shown in FIG. 2. The method 100 may begin with step 102, by determining that the control system 40 is operational. That is, that power is being provided to the control system 40 and, or example, the infotainment system 16 and the communications device 34 are functional and able to enable pairing and in-vehicle operation of the mobile device 14. In at least some implementations, an ignition or start mode of the vehicle may be actuated, where this may mean that the powertrain system is ready for use, or merely that at least some part of a vehicle electrical system is operational (e.g. in some vehicles this may be called accessory mode where electrically operated components can be used even if the vehicle engine or motor is not operating). When it is determined that the control system 40 is on and operational, the method 100 advances to step 104.

In step 104, it is determined if a mobile device 14 is detected by the control system 40 via the communications device 34. The communications device 34 has a working or effective range at which wireless detection and communication with a mobile device 14 is possible. When the mobile device 14 enters the range of the communications device 34, the mobile device 14 may be detected by the control system 40 through the communications device 34 via wireless communication. For example, the mobile device 14 may transmit a signal that is received by the communications device 34 when the mobile device 14 is within the range of the communications device 34. The communications device 34 may then indicate to the control system 40 that the mobile device 14 has been detected. When the mobile device 14 is detected, the method 100 continues to step 106.

In step 106, it is determined whether the mobile device 14 is within the interior 21 of the vehicle 10. The control system 40 may utilize the communications device 34 to determine the location of the mobile device 14 relative to the vehicle 10. To determine that the mobile device 14 is within the interior, as shown by FIG. 1, the control system 40 may estimate the distance from the device transmitter 42 of the mobile device 14 to the receiver 38 of the communication device 34 or the distance from the transmitter 36 of the communications device 34 to the device receiver 44 of the mobile device 14 based on the strength of the communication (wireless signal) or from time-of-flight calculations between the mobile device 14 and the communications device 34 of the vehicle 10. In at least some implementations, the location of the mobile device 14 is determined with UWB transmissions which enable accurate location determination.

In implementations where the communications device 34 has a single receiver 38 as shown by FIG. 1, the mobile device 14 may be determined to be within the vehicle 10 when the distance between the mobile device 14 and the receiver 38 of the communications device 34 is less than the distance between the receiver 38 and the boundary of the interior of the vehicle 10. In other implementations, the communications device 34 may have multiple receivers 38, 39 positioned spaced apart throughout the interior of the vehicle 10. The signal strength between the mobile device 14 and each of the receivers 38, 39 may be determined, and the location of the mobile device 14 may be determined relative to each of the receivers 38, 39 as described previously. The distances of the mobile device 14 to each of the receivers 38, 39 may be used to triangulate the location of the mobile device 14 relative to the vehicle 10 to determine whether the mobile device 14 is within the interior of the vehicle 10.

The location of the mobile device 14 relative to the vehicle interior 21 may also be determined using time-of-flight calculations, where the distance between the mobile device 14 and the communications device 34 is determined based on the time elapsed between sending and receiving communication between the mobile device 14 and the communications device 34. When the speed at which the communication travels is known, which in some implementations may be the speed of light, the time between sending and receiving communication may be multiplied by the speed of the communication to determine the distance from the mobile device 14 to the receiver 38 of the communications device 34. When the distance calculated from the elapsed time is less than a predetermined threshold, the mobile device 14 may be determined to be within the vehicle 10. Multiple receivers 38, 39 or transmitters 36, 37 of the communications device 34 may be positioned throughout the vehicle 10, the distance may be calculated between each of the receivers 38, 39 or transmitters 36, 37 and the mobile device 14 to triangulate the location of the mobile device 14 relative to the vehicle 10 to determine whether the mobile device 14 is within the interior of the vehicle 10.

In at least some implementations, other information may be used, for example, to determine that at least one occupant is within the vehicle interior 21 after the mobile device 14 is determined to be within the vehicle interior 21. This may be done, for example, to avoid attempts to pair the mobile device to the control system 40/infotainment system 16 when nobody is within the vehicle interior 21. Factors such as actuation of an input within the vehicle interior 21 (e.g. an ignition or vehicle “on” switch), one or more vehicle doors 20 being unlocked or opened, determining a vehicle occupant has entered the vehicle 10 using a seat sensor 32 or other interior sensor, detecting that the key fob or a vehicle access device used to access the vehicle 10 is within the vehicle 10 may indicate that a user of the mobile device 14 is within the vehicle 10.

When one or more of the other factors occur, and the mobile device 14 is determined to be located within the vehicle interior 21, the method 100 may continue to step 108. However, in at least some implementations, when one or more of the other factors do not occur, the method 100 may end without advancing to step 108. Further, in at least some implementations, the method may proceed to step 108 after detecting in step 106 that the mobile device 14 is within the vehicle interior 21 and without determining whether an occupant of the vehicle is within the interior 21.

In at least some implementations, step 104 where the mobile device 14 is detected by the control system 40 via the communications device 34 may be included in step 106. By determining that the mobile device 14 is within the interior of the vehicle 10, the mobile device 14 may be considered as “detected” by the vehicle 10. In at least some implementations, detection of the mobile device 14 when the mobile device 14 is not within the interior is not separately determined.

If the mobile device 14 is not determined to be within the interior of the vehicle 10, the method 100 may end or loop back to step 102 for another iteration. If the mobile device 14 is determined to be within the vehicle 10, the method 100 continues to step 108. For example, when a mobile device 14 is detected but determined to be outside of the vehicle 10, then the method may monitor (e.g. determine again, at any desired period of time) the location of the mobile device 14 to promptly detect when the mobile device 14 is moved into the vehicle interior 21.

In step 108, when the mobile device 14 is determined to be within the interior of the vehicle 10, the mobile device 14 is paired with the infotainment system 16 of the vehicle 10 via the communications device 34. When this occurs, media being played on the mobile device 14 is transferred to and played through the infotainment system 16 and its associated speakers and/or displays. So that, in at least some implementations, the infotainment system 16 is configured to playback media from the mobile device 14 or output media to the mobile device 14. For example, an ongoing phone call may be continued using the microphone(s) and speaker(s) of the infotainment system 16 rather than the microphone and speaker of the mobile device 14. As another example, ongoing media playback may be transferred from the phone to the infotainment system for presentation to the vehicle occupant(s) via the speakers and/or display(s) in the vehicle 10.

In at least some implementations, subsequent to pairing the mobile device 14 with the vehicle 10, the mobile device 14 may be removed from the vehicle 10. When it is determined that the mobile device 14 is no longer in the vehicle 10, the mobile device 14 may be disconnected from the infotainment system 16. When this occurs, media playback or use (e.g. audio, video, phone call, etc.) may be resumed using components integrated with the mobile device 14 or one or more external devices (e.g. devices outside the vehicle that the phone may be connected/paired with).

If more than one mobile device 14 has been previously paired or connected to the vehicle 10, and more than one mobile device 14 is determined to be located within the vehicle 10, the memory of the control system 40 or of the infotainment system 16 may have a list of priority stored where each known mobile device 14 is assigned a level of priority, or where one mobile device is listed as a default or highest priority device (e.g. the mobile phone of the person/driver/vehicle operator who most often uses the vehicle). In at least some implementations, when more than one mobile device 14 is within the vehicle, the mobile device 14 with the higher priority is paired to the infotainment system 16 over another mobile device of lower priority. For example, the order of the priority list may be pre-set by the operator or vehicle occupant, chronologically determined by the date/time of first connection of the mobile device 14, among other ways. In at least some implementations, the first mobile device 14 to pair with the vehicle control system 40 during the particular use of the vehicle 10 remains connected with the control system 40. In at least some implementations, the control system 40 can communicate via the infotainment system 16 to the user that multiple mobile devices have been detected within the vehicle 10 and allow an occupant of the vehicle 10 to choose which mobile device is to be paired with the vehicle control system 40.

By verifying that the mobile device 14 is within the vehicle 10 before pairing the mobile device 14 with the vehicle control system 40 or enabling mobile device functions to occur via the infotainment system 16, interruptions in phone calls, audio, video, or other types of media transfer caused by prematurely pairing the mobile device 14 to the infotainment system 16 can be avoided. For example, a user of the mobile device 14 may be making a phone call using the integrated speaker and microphone of the mobile device 14, while a vehicle occupant other than the user of the mobile device 14 enters and powers on the vehicle 10, or the vehicle is powered on remotely. Remotely powering on the vehicle may be done, for example, via a remote starting function or the like, such as to turn on a HVAC system of the vehicle 10 before occupants enter the vehicle 10.

When the control system is operational and the mobile device 14 is within range of the communications device 34, the mobile device 14 may automatically be paired with the vehicle control system 40, and then the phone call of the mobile device 14 (or other audio interaction, such as an audio or video meeting or call) may be unintentionally transferred to the speakers and microphones of the vehicle 10, even when the person using the mobile device 14 is not within the vehicle 10. This may occur even though the mobile device user is at significant distance from the vehicle and not able to hear the output from the infotainment system 16. In such instances, the user is unable to participate in the phone call, which is frustrating for the user, other participants in the phone call, and any vehicle occupants (especially when not participants in the phone call). Further, this permits vehicle occupants (i.e. people within the vehicle interior) to hear and participate in the phone call, even when the user of the mobile device 14 cannot, until the mobile device 14 is disconnected from the vehicle.

As another example, a user of the mobile device 14 may be playing media such as audio and/or video through the integrated speaker or the display of the mobile device 14, or through an external device in communication with the mobile device 14. When the mobile device 14 is within range of the communications device 34, the media being played on the mobile device 14 may unintentionally be transferred to the infotainment system 34 (e.g. the speakers and microphones of the vehicle 10), interrupting the user's ability to continue watching or listening to the media on the mobile device 14, until the mobile device 14 is disconnected from the vehicle 10. Disconnection may occur, for example, by the mobile device 14 being moved out of the range of the communications device 34, or by manually terminating the connection at either the mobile device 14 or the infotainment system 16 of the vehicle 10.

The location of the mobile device 14 may be determined periodically, as desired. If it is determined, subsequent to step 108, that the mobile device 14 has been moved outside of the interior of the vehicle 10, the connection/pairing between the mobile device 14 and the vehicle 10 may be terminated and the method 100 may end, even when the mobile device 14 remains within the working range of the communications device such that the mobile device could remain paired to the vehicle. In this case, media transfer between the mobile device 14 and the infotainment system 16 is discontinued so that a user of the mobile device who is not within the vehicle interior 21 can use the mobile device without playback occurring via the infotainment system 16.

What is claimed is:

1. A method for pairing a mobile device to an infotainment system of a vehicle comprising:
determining that a control system of the vehicle and an infotainment system of the vehicle are operational;
determining that a mobile device is within an interior of the vehicle; and
pairing the mobile device to the infotainment system of the vehicle.

2. The method of claim 1, further comprising determining that an occupant is within the interior of the vehicle.

3. The method of claim 2 wherein determining that an occupant is within the interior of the vehicle is accomplished by detecting one or more of: actuation of an input within the interior of the vehicle, opening of one or more vehicle doors, that a vehicle seat is occupied using a seat sensor or other interior sensor, or that a key fob or a vehicle access device used to access the vehicle is within the interior of the vehicle.

4. The method of claim 1, wherein determining that the mobile device is within the interior of the vehicle includes determining that a distance that the mobile device is from a receiver of a communications device of the vehicle is less than a distance between the receiver and a boundary of the interior of the vehicle.

5. The method of claim 4, wherein the distance between the mobile device and the receiver of the communications device is determined using a signal strength between the mobile device and the receiver of the communications device or time-of-flight calculations.

6. The method of claim 5, wherein the signal is an ultra-wideband signal.

7. The method of claim 1, wherein pairing the mobile device to the infotainment system of the vehicle includes permitting media from the mobile device to be transferred to and played through the infotainment system.

8. The method of claim 7, wherein media includes phone calls, audio, and video.

9. The method of claim 1, wherein, when multiple mobile devices are determined to be within the interior of the vehicle, a mobile device having a higher priority than the other mobile devices is paired to the infotainment system of the vehicle and the order of priority may be pre-set by a vehicle occupant or chronologically determined by the date or time of first connection to the vehicle.

10. The method of claim 1, further comprising determining that the mobile device is no longer in the vehicle and disconnecting the mobile device from the infotainment system.

11. The method of claim 10, wherein disconnecting the mobile device is done by the vehicle control system even when the mobile device is within a distance of the vehicle in which wireless connection of the mobile device to the vehicle control system is still possible.

12. A system for pairing a mobile device to an infotainment system of a vehicle comprising:
a vehicle communications system configured to communicate with a mobile device;
an infotainment system configured playback media from the mobile device or output media to the mobile device; and
a control system, configured to communicate with the vehicle communications system and the infotainment system, determine the vehicle is ready for use, determine the mobile device is within an interior of the vehicle, and pair the mobile device to the infotainment system of the vehicle.

13. The system of claim 12, wherein the control system is configured to determine that a user of the mobile device is within the vehicle, wherein determining the user of the mobile device is within the vehicle includes determining a vehicle powertrain system has been switched to an on position, one or more vehicle doors have been unlocked or opened, a vehicle occupant has entered the vehicle using a seat sensor or other interior sensor, detecting that the key fob or a vehicle access device used to access the vehicle is within the vehicle, or a change in the position of a drivetrain of the vehicle has occurred.

14. The system of claim 12, wherein determining the mobile device is within the interior of the vehicle includes determining a distance that the mobile device is from a receiver of the communications device of the vehicle is less than a distance between the receiver and a boundary of the interior of the vehicle.

15. The system of claim 14, wherein the distance between the mobile device and the receiver of the communications device is determined using a signal strength between the mobile device and the receiver of the communications device or time-of-flight calculations.

16. The system of claim 12, wherein pairing the mobile device to the infotainment system of the vehicle includes permitting media from the mobile device to be transferred to and played through the infotainment system.

17. The system of claim 16, wherein media includes phone calls, audio, and video.

18. The system of claim 12, wherein, when multiple mobile devices are determined to be within the interior of the vehicle, a mobile device having a higher priority than the other mobile devices is paired to the infotainment system of the vehicle and the order of priority may be pre-set by a vehicle occupant or chronologically determined by the date or time of first connection to the vehicle.

19. The system of claim 12, wherein the control system is configured to determine when the mobile device is no longer in the vehicle and disconnect the mobile device from the infotainment system.

20. The system of claim 19, wherein disconnecting the mobile device is done by the vehicle control system even when the mobile device is within a distance of the vehicle in which wireless connection of the mobile device to the vehicle control system is still possible.
